(19) United States
(12) Patent Application Publication
(10) Pub. No.: US 2025/0260770 A1
(43) Pub. Date: Aug. 14, 2025

(54) ENHANCED CONTROL OF PRESENTER QUEUE NOTIFICATIONS

(71) Applicant: Microsoft Technology Licensing, LLC, Redmond, WA (US)

(72) Inventors: Amer Aref HASSAN, Kirkland, WA (US); Shaun Paul DUNNING, San Clemente, CA (US); Scott Edward VAN VLIET, Ladera Ranch, CA (US)

(21) Appl. No.: 18/437,127

(22) Filed: Feb. 8, 2024

(51) Int. Cl. H04M 3/56; H04L 12/18; H04N 7/15

(52) U.S. Cl. CPC H04M 3/566; H04L 12/1831; H04M 3/568; H04N 7/157

(57) ABSTRACT

A system provides notifications when a meeting participant interrupts another participant who has been selected as a speaker during a meeting. A notification is displayed when a first participant raises their hand, and prior to the first participant having a chance to speak, the system detects that a second participant has interrupted. The notification can be in the form of an animated gesture to gently remind the second participant that the first participant had requested to speak and that the second participant had taken the first participant's turn. The animation can include an icon that increases in size over time or the system performs other forms of a graphical transformation. The system can also control the volume of the interrupting user, which may be decreased after the interrupting user speaks for a period of time. The system can also utilize AI models to analyze the context of a conversation to determine if a participant is interrupting a designated speaker.

### BACKGROUND

There are a number of different types of collaborative systems that allow users to communicate. For example, some systems allow people to collaborate by sharing content using video and audio streams, shared files, chat messages, etc. Some systems provide user interface formats that allow users to share content with an audience. Such systems can provide specific sets of permissions that allow users to take specific roles during certain parts of a meeting. For example, during a speech, a presenter may have rights to broadcast to an audience, and audience members can ask questions, etc.

Although some systems can provide specific sets of permissions for users to take on certain roles during certain parts of a meeting, such systems have a number of drawbacks. For instance, when a presenter is addressing an audience, some systems set permissions to allow audience members to address all participants of a meeting in case an audience member has a question. Although this arrangement helps with communication in some scenarios, this can lead to a situation where audience members overextend the intent of the audience permissions. Interruptions can become too long or too frequent, and this can lead to ineffective meetings.

Some systems address this issue by having a user, such as a moderator, manually control permissions of the audience members. However, this process can lead to a number of other inefficiencies and security issues. A moderator may have to provide a number of inputs to change permissions to some users who tend to interrupt presentations of other participants. Not only is this process inefficient and impossible to scale at large meetings, this manual process can lead to a situation where a moderator may forget to change permissions back to an original setting. Modified permissions can become uncoordinated and inconsistent with the goal of a meeting. These uncoordinated settings can detract from the features of a communication system and distract users during meetings. Such distractions can cause participants of a meeting to miss salient information. In addition, this process of having some users to provide a number of manual steps to change user permissions during a meeting can lead to unintended permission settings. Someone may make a mistake and grant unintended video content sharing rights, or leave rights in a state beyond an intended time period. Such an arrangement can create a number of attack vectors and expose stored content to a number of security threats.

When meeting permissions are not coordinated with the goals of a meeting, salient information that was intended to be communicated in a meeting can be missed. This causes a need for users to communicate using other systems and other resources to share information. This can also cause the need for prolonged meetings or cause a need for additional meetings. This can lead to an inefficient user interaction model and lead to inefficient use of computing systems, particularly if users need to use additional resources to communicate missed information. Thus, in addition to having a number of security issues, some current systems can create redundant use of computing resources and a number of inefficiencies with respect to the use of network resources, storage resources, and processing resources.

### SUMMARY

The disclosed techniques address the technical issues pertaining to uncoordinated speakers of a meeting by providing technical solutions that control notifications to users who are speaking out of turn. In some embodiments, a system can provide gentle prompts when a user interrupts another user who has their virtual hand raised during a meeting. For example, consider a scenario where a first participant raises their hand, and prior to the first participant having a chance to speak, the system detects that a second participant interrupts. In response to the detection of this scenario, a graphical notification of a hand-raise gesture is enhanced to gently remind the second participant that the first participant had requested to speak and that the second participant had taken the first participant's turn. In some configurations, a hand-raise gesture can be in any form of input using any type of detection device. For example, the hand-raise gesture can be an input generated from a camera that detects a physical hand raise, or the input can be generated from a microphone that detects a voice input indicating a person wanting to speak, or the input can be from a button or touch-pad gesture. The graphical notification can be an enhancement of a graphical indicator such as a hand-raise icon displayed exclusively to the second participant. For example, the enhancement can be an animation where the icon increases in size over a time period or the system performs other forms of a transformation.

In some embodiments, the system can perform different types of notification actions based on the detection of specific participant activity. In such embodiments, the system can delay a notification, amplify a notification, or take other combinations of actions when specific types of participant behavior are detected. A system can create user activities profiles, which can include audio profiles and other identifiers, such as a timeslot for a role, etc. During a meeting, the system can identify participants through voice recognition and the use of each person's audio profiles. This can enable a system to identify individual people in a conference room who are sharing a common microphone. For illustrative purposes, consider a scenario where a meeting includes 4 individuals, User A through User D. During the meeting, the system continually analyzes the voice of each user and identifies each person's voice. At first, User B and User C start conversing. User A then performs a hand raise gesture that causes the system to select User A as a designated presenter. Then, User D starts talking out of turn. The system can take one or more actions based on a level associated with the detected behavior. For example, if activity is detected to be less than alpha, the system categorizes this activity as a gesture and the system does not display a graphical cue to serve as a reminder that User D is interrupting. If activity is larger than beta, a graphical cue is amplified. If the detected activity is in between alpha and beta, and it is the first time that the activity is detected, the activity is ignored and the system does not display a graphical cue to serve as a reminder that User D is interrupting. However, if the detected activity is in between alpha and beta, and it is not the first time that the activity is detected, the system causes the cue to be amplified. The amplification can be viewed by a specific user or by all users. If displayed to all users, there may be a visual association that relates the graphical cue, e.g., the graphical notification, to a user who is detected as the interrupting participant. The activity level can be any performance metric, which may include a volume level, a degree of movement, a number of spoken words, etc. Alpha and beta are used as examples of sample thresholds for any detected activity level. In these examples, each threshold can be at the same level or at different levels.

In some embodiments, the system can also automatically control permissions of a user who is speaking out of turn. If a person is speaking out of turn, the system can allow that user to speak to a group for a predetermined period of time, and then after that predetermined time period, the system can mute that user and/or prevent them from broadcasting an audio signal to an audience. The system can monitor a timer that starts when a participant speaks out of turn and a voice signal of that participant exceeds a threshold, e.g., a volume threshold, a word count threshold, etc. When the system determines that the time period has lapsed, the system can change the permission of that participant so they cannot broadcast an audio signal to more than one other person. A participant can be considered as speaking out of turn when another participant raises their hand before that participant raises their hand and the system detects that the participant starts to speak before the other participant.

In some embodiments, the system can utilize an AI model, such as a large language model, to determine if a participant is interrupting another participant. For example, a text transcript can be generated in real time during a meeting. That text can be sent to a large language model (LLM) with a prompt to instruct the LLM to interpret the conversation. The prompt can associate users with different sections of text. The prompt can also instruct the LLM to determine if a first person is interrupting a second person. If the LLM determines that a first person is being interrupted by a second person while that first person is selected as an active speaker, the system can generate a notification to the second person to let them know they are interrupting the first person. The system can also control permissions for the second person and either reduce the volume of their audio broadcast to other users or mute their ability to contribute a speech input to a meeting. The permissions can be automatically reset after a period of time to a default volume so the second person can contribute at a later time.

The techniques disclosed herein can provide a number of technical effects including enhancing the security of a communication system. By automating the assignment of roles and permissions and an order in which participants speak, a system can enhance security by mitigating the need for users to perform manual steps to change permissions during an event. Automatically assigned permissions that are based on a sequence of events of a hand raise an order in which users are speaking can reduce the need for a manual input for changing roles and/or permissions and thereby reduce introduction of human error. Such an arrangement can reduce the number of attack vectors and exposure to a number of security threats. For example if a user manually assigns a role to a participant and then does not relinquish rights for a microphone broadcast mode when they are no longer a speaker, that person may inadvertently have an unwanted broadcast.

In addition to improving the security of a system, the techniques disclosed herein can provide a number of efficiencies. By providing an updated roles and notifications for each presenter and audience members, meeting participants can adjust the level of detail of their presentation and focus on salient points with minimal interruptions. When information is organized more accurately and with fewer manual inputs, audience members are less likely to miss salient information during an event. Such benefits can increase the efficiency of a computing system by reducing the number of times a user needs to interact with a computing device to obtain information, e.g., prolonging meetings, retrieving meeting recordings, requesting duplicate copies of previously shared content, etc. Thus, various computing resources such as network resources, memory resources, and processing resources can be reduced.

The techniques disclosed herein also provide a system with a granular level of control when aligning permissions to specific roles of an event. Such features can also lead to a more desirable user experience. In particular, by automatically controlling user roles based on a gesture, such as a hand raise, a system can reduce the number of times a user needs to interact with a computing device to control roles and security permissions. This can lead to the reduction of manual data entry that needs to be performed by a user. By reducing the need for manual entry, inadvertent inputs and human error can be reduced. This can ultimately lead to a reduction in undesirable permissions and more efficient use of computing resources such as memory usage, network usage, processing resources, etc.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for generating a notification to a meeting participant who is speaking out of turn.

FIG. 2A is a first stage of a process for generating a notification to a meeting participant who is speaking out of turn.

FIG. 2B is a second stage of a process for generating a notification to a meeting participant who is speaking out of turn.

FIG. 2C is a third stage of a process for generating a notification to a meeting participant who is speaking out of turn.

FIG. 2D is a fourth stage of a process for generating a notification to a meeting participant who is speaking out of turn.

FIG. 3A is a first stage of a process for amplifying a notification to a meeting participant who is speaking out of turn.

FIG. 3B is a second stage of a process for amplifying a notification to a meeting participant who is speaking out of turn.

FIG. 3C is a third stage of a process for amplifying a notification to a meeting participant who is speaking out of turn.

FIG. 3D is a fourth stage of a process for amplifying a notification to a meeting participant who is speaking out of turn.

FIG. 3E is a firth stage of a process for amplifying a notification to a meeting participant who is speaking out of turn, where the fourth stage includes also muting the participant who is speaking out of turn.

FIG. 4 shows an example of a user interface arrangement having a presentation region, a group region and a queue, where the system displays a notification in association with a meeting participant who is speaking out of turn.

FIG. 5 shows a block diagram of a system that utilizes a large language model to determine if a first participant is interrupting another a second participant.

FIG. 6 is a flow diagram showing aspects of a routine for generating a notification to a meeting participant who is speaking out of turn.

FIG. 7 is a diagram illustrating a distributed computing environment capable of implementing aspects of the techniques and technologies presented herein.

FIG. 8 is a computer architecture diagram illustrating a computing device architecture for a computing device capable of implementing aspects of the techniques and technologies presented herein.

### DETAILED DESCRIPTION

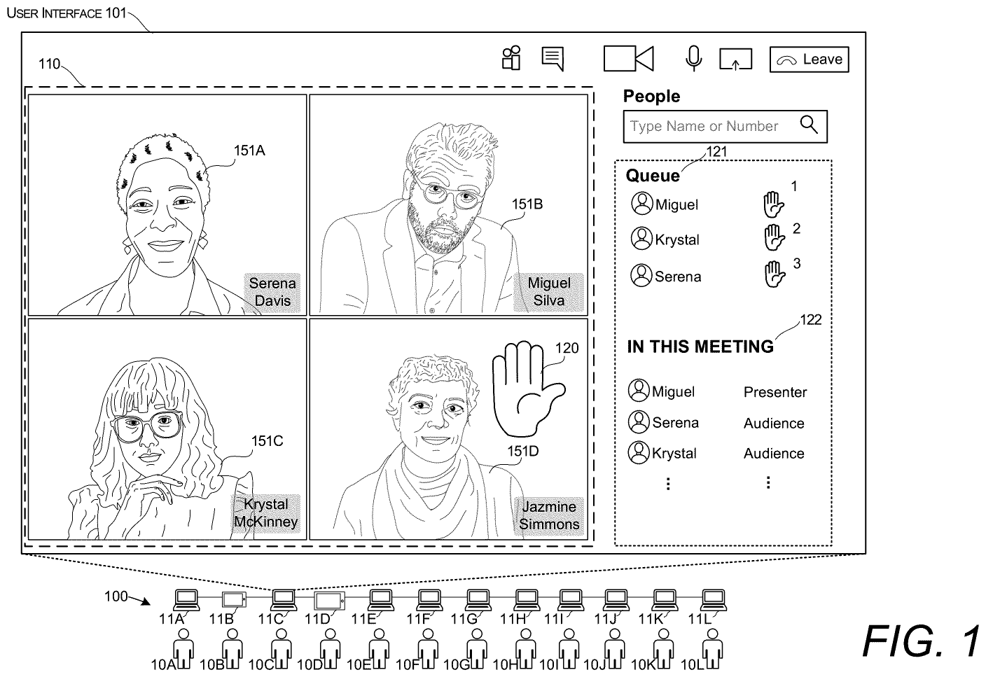

FIG. 1 illustrates an example system 100 that provides notifications when a meeting participant interrupts another participant who has been selected as a speaker during a meeting. A notification is displayed when a first participant raises their hand, and prior to the first participant having a chance to speak, the system detects that a second participant has interrupted. The notification can be in the form of an animated gesture to gently remind the second participant that the first participant had requested to speak and that the second participant had taken the first participant's turn. The animation can include a graphical representation that increases in size over time or the system performs other forms of a graphical transformation. The system can also provide audible or tactile notifications. The system can also control the volume of the interrupting user, which may be decreased after the interrupting user speaks for a period of time. The system can also utilize AI models to analyze the context of a conversation to determine if a participant having a particular role is interrupting a designated speaker.

In the example of FIG. 1, there are a number of users in a meeting, where User 1 10A, Serena Davis, is associated with a computing device 11A, User 2 10B, Miguel Silva, is associated with another computing device 11A, User 3 10C, Krystal Mckinney, is associated with another computing device 11C, and User 4 10D, Jazmine Simmons, is associated with yet another computing device 11D, and other users 10E-10L are associated with other corresponding devices 11E-11L. Each user 10 is represented in a user interface 101 by a rendering 151, e.g., the first user 10A is represented by a first rendering 151A, the second user 10B is represented by a second rendering B.

The user interface can include a participant region 110, a speaker queue 121, and a participant status list 122. The speaker queue 121 can list participants who have expressed an interest in speaking by any type of computerized input. Each person can be ordered in the queue based on an order of an input received by each person or each person can be ordered by other factors, e.g., by title or role. Each person in the queue can become a speaker by following the order of the queue.

The first person in the queue, e.g., Miguel, is the active speaker. The active speaker has permissions and settings to broadcast video and audio streams to all participants. Also, while that person is the active speaker, the system monitors the volume or activity of other users and generates notification for those other users if the system determines if they are interrupting the active speaker. When the active speaker is done speaking, e.g., by allotted time or by providing an input indicating completion of a presentation, the next person in the queue, e.g., Krystal, can become the active speaker. The status list can show current roles for each person in the meeting, e.g., active speaker, audience member, etc.

The system can generate a notification 120 to a meeting participant that is speaking out of turn. This notification serves as a reminder that they are interrupting a designated presenter. While the designated presenter is broadcasting a live audio and video streams to audience members, the system allows the interrupting participant to also broadcast live audio and video streams to audience members. For illustrative purposes, the interrupting participant is also referred to herein as an interjecting participant. This gives the active speaker the ability to broadcast a presentation but also allows other participants to concurrently communicate audio and video signals to ask questions or provide cues. However, if a particular participant who is not a designated presenter is determined to be interrupting the designated presenter beyond one or more thresholds, the system provides reminders to that particular participant that they are interrupting the presenter. The one or more thresholds can be based on a length of time, a volume, a number of words, etc. The one or more thresholds can also be based on a context of the interruption. For example, if a language model determines that a particular participant who is not a designated presenter interrupts with a question that is off-topic, the system may generate reminders to that particular participant that they are interrupting the presenter.

In the example of FIG. 1, consider a scenario where the system detects that Miguel provides an input indicating an interest in becoming a designated presenter. This can be done by detecting an input, e.g., that he raises his hand by detection using a camera, detection of a button activation, or by the use of AI detecting a pattern in his speech. The system can grant that person a designated speaker role, e.g., a designated presenter. In this example, the system can receive an input from a computing device 11B of a participant 10B for invoking an operating state of the system 100 granting the first participant 10A with speaker permissions. The other participants 10A and 10C-10L of the meeting are assigned with audience permissions.

Once the system selects a designated presenter, the system is configured to monitor the participants that are not designated as presenters, also referred to herein as “other participants.” The system determines that other participants are interrupting a designated presenter when the system receives a subsequent input that indicates that a participant, such as a participant 10D, is speaking while the designated presenter, e.g., participant 10B, is assigned with the speaker role. In the current example, the system is configured to monitor participants with audience roles, such as users 10A and 10C-10L. In some configurations, the system may be configured to only monitor the participants with audience roles, e.g., in the current example users 10A and 10C-10L, and not monitor other users, such as administrators or moderators.

In response to detecting that the participant 10D is speaking while the participant 10B is assigned with the speaker permissions, the system can cause a computing device 11D associated with the participant 10D to generate a graphical element 120 indicating that the second participant 10D is speaking out of turn. The graphical element 120 can be displayed only to the participant 10D who is speaking out of turn. In some embodiments, the graphical element 120 can be displayed to all audience members but displayed in association with the participant 10D who is speaking out of turn. This allows all participants to help provide cues to the participants speaking out of turn.

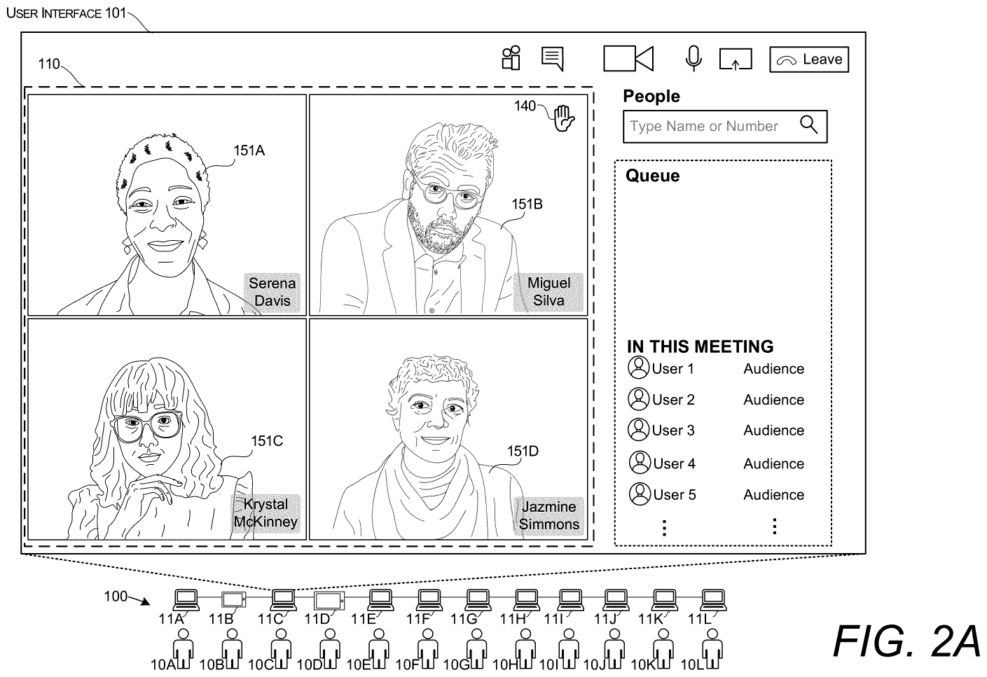

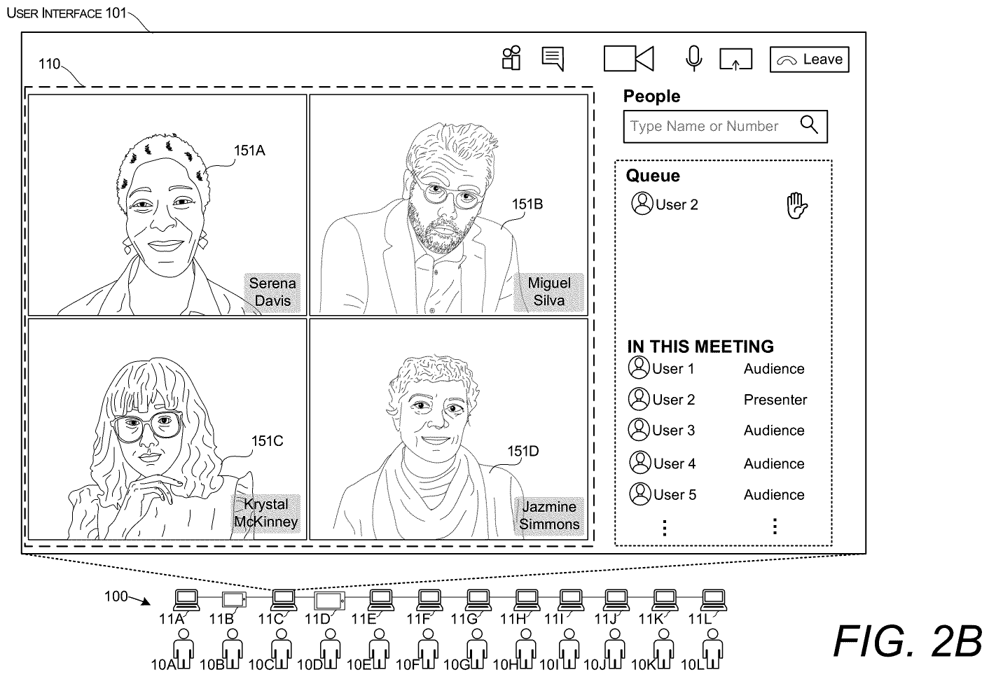

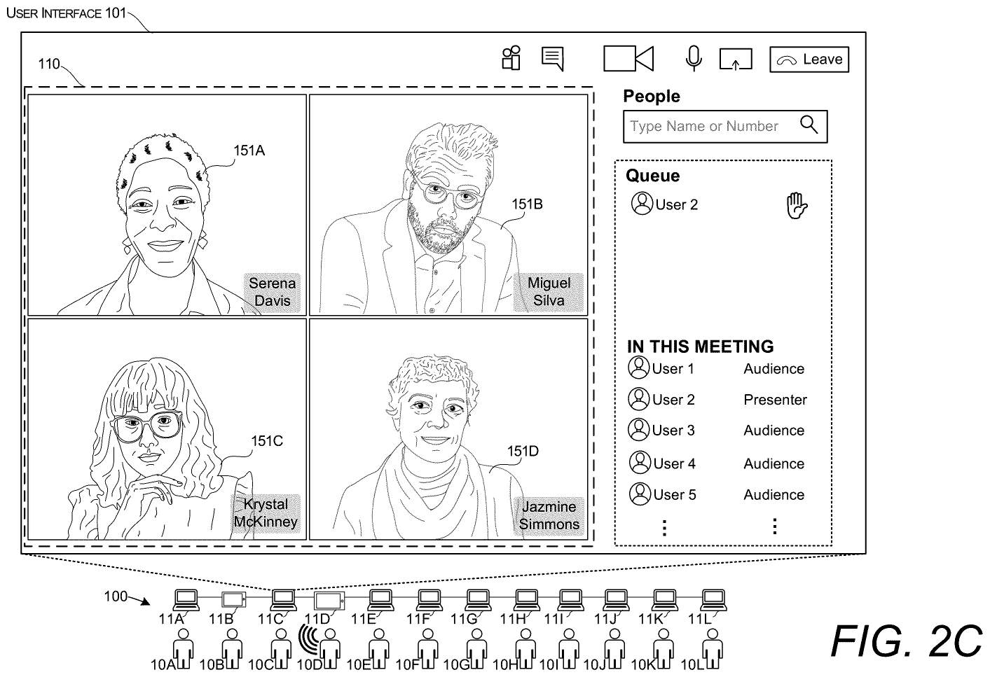

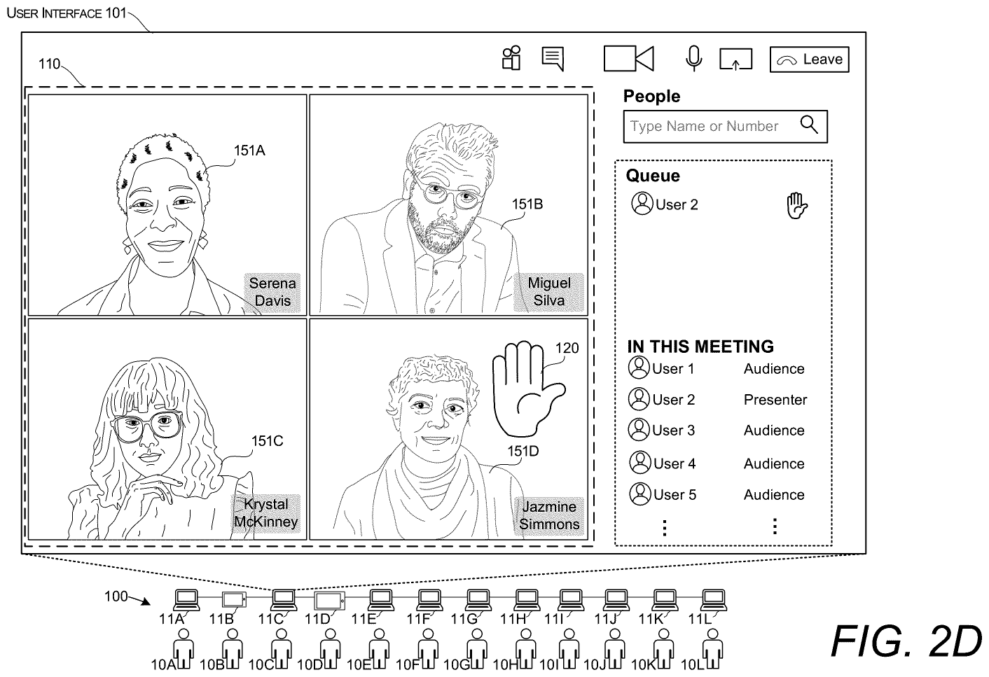

In some embodiments, the system can cause a generation of a graphical element 120 that is displayed in association with a participant that is interrupting a designated presenter. This embodiment can configure the graphical element to identify the user who is speaking out of turn. An example of such an embodiment is shown in FIGS. 2A-2D. As shown in FIG. 2A, the system can start with an input from User 2 10B indicating that they raised their hand. Another graphical indicator 140 can be displayed to show that User 2 10B has raised their hand. Then, as shown in FIG. 2B, the system transitions to a state where User 2 10B is added to a speaker queue, and the system designates User 2 10B as a designated presenter. Then, as shown in FIG. 2C, the system detects that another user, User 4 10D, starts to speak before User 2. In response to detecting that User 4 started to speak before User 2, the system generates a graphical element 120 that is displayed in association with User 4. This can indicate that User 4 is speaking out of turn.

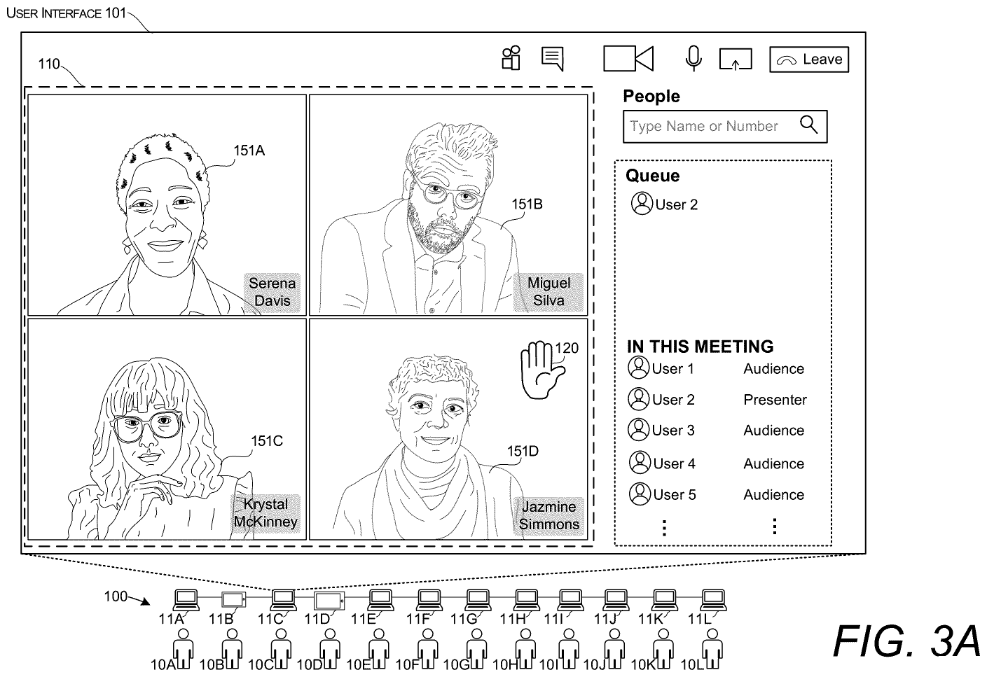

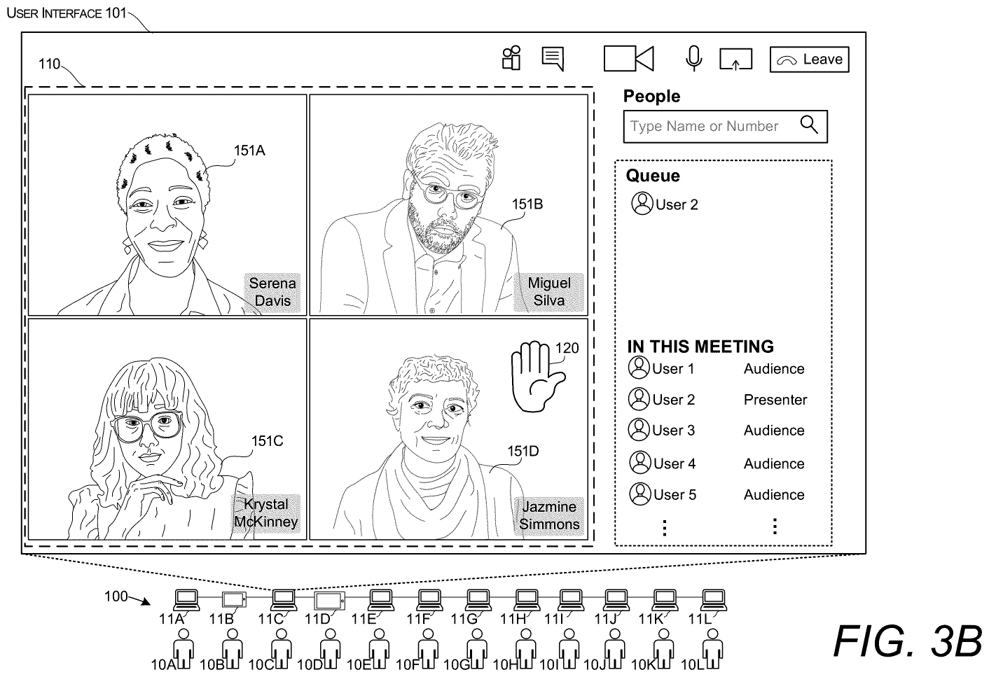

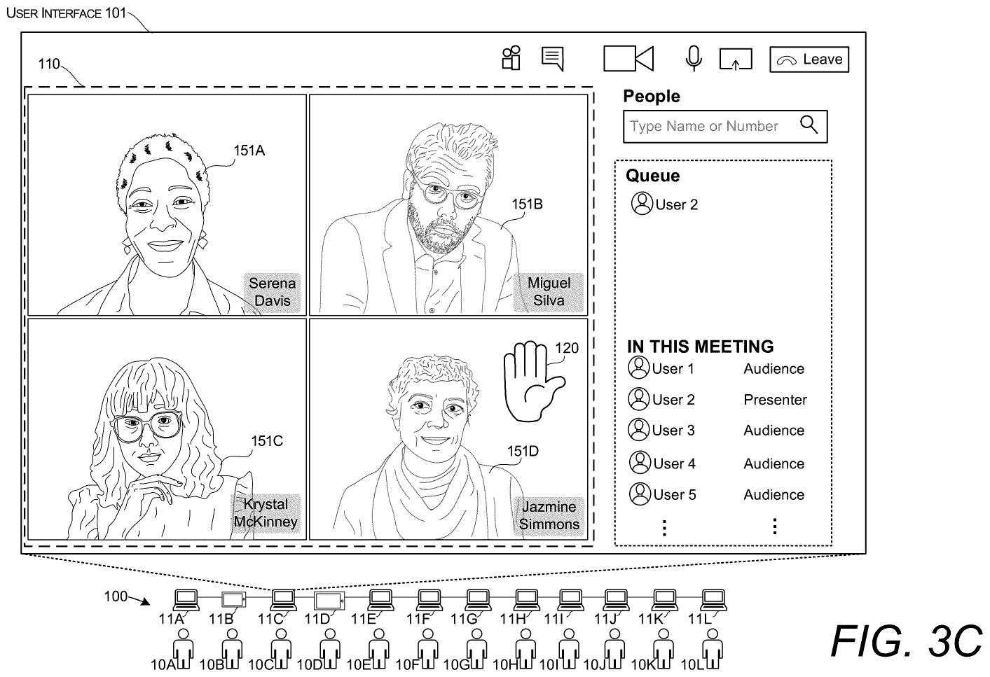

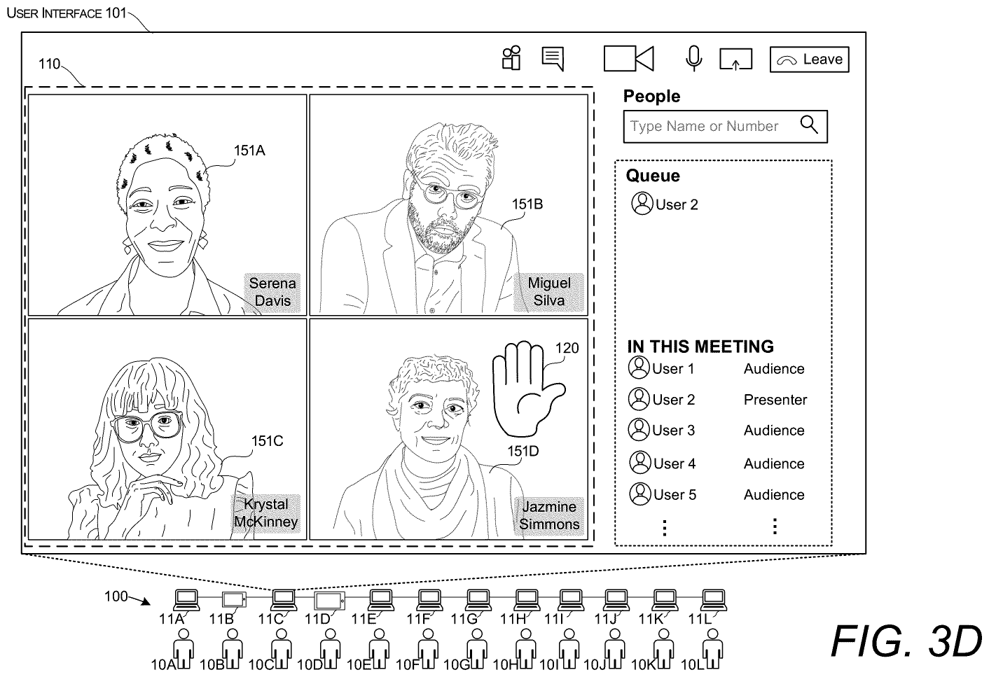

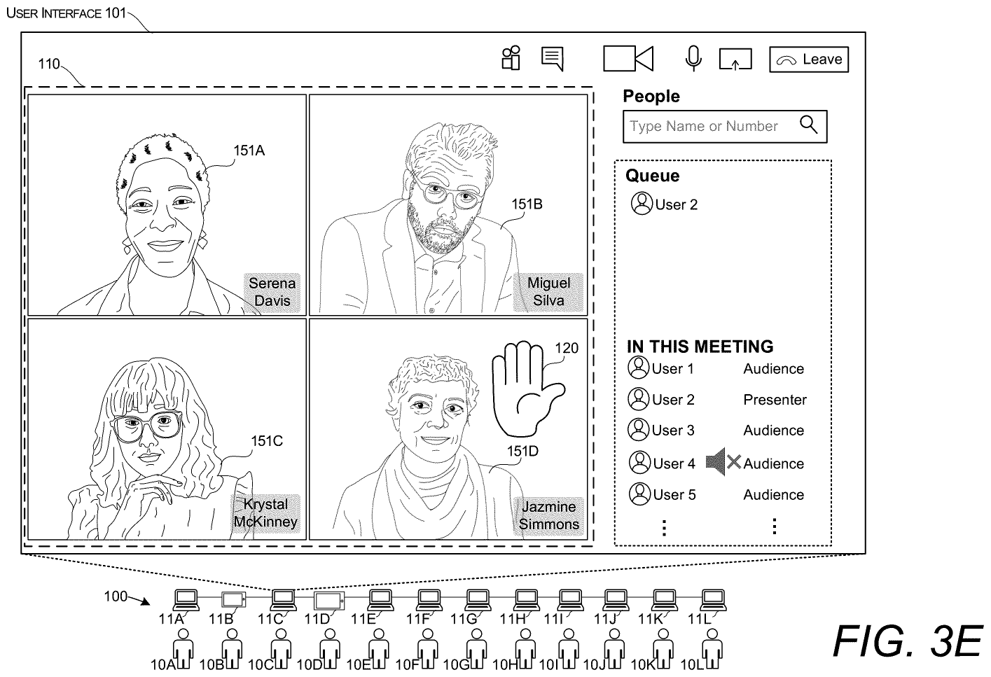

In some embodiments, the system can cause a transformation of the graphical element 120 over time. This embodiment can configure the graphical element to increase in size over time to identify the user who is speaking out of turn. An example of such an embodiment is shown in FIGS. 3A-3D. As shown in FIG. 3A, in response to detecting that User 4 has interrupted the designated presenter, User 2, the system can generate a notification 120 for User 4. Then, as shown in FIG. 3B through FIG. 3D, the notification 120 increases over time. This can include causing the graphical element 120 to increase in size over time while the subsequent input indicates that User 4 10D is speaking over User 2 who is the designated presenter. The rate of the size increase and the size of the graphical element is based on a priority of first participant or a characteristic of the subsequent input. For example, if the designated presenter, User 2, is a higher ranking employee over User 4, and/or User 4 has spoken for more than a threshold period of time or is speaking over a threshold volume, the system can cause the notification 120 to increase at a faster rate or to a larger size versus a scenario where User 4 does not rank higher and/or does not meet the speaking criteria.

In some embodiments, the system can perform different types of notification actions based on the detection of specific participant activity. In such embodiments, the system can delay a notification, amplify a notification, or take other combinations of actions when specific types of participant behavior are detected. A system can create user activities profiles, which can include audio profiles and other identifiers, such as a timeslot for a role, etc. During a meeting, the system can identify participants through voice recognition and the use of each person's audio profiles. This can enable a system to identify individual people in a conference room who are sharing a common microphone. For illustrative purposes, consider a scenario where a meeting includes 4 individuals, User A through User D. During the meeting, the system continually analyzes the voice of each user and identifies each person's voice. At first, User B and User C start conversing. User A then performs a hand raise gesture that causes the system to select User A as a designated presenter. Then, User D, who is not in a presenter role, starts talking out of turn. The system can take one or more actions based on a level associated with the detected behavior.

For example, if activity is detected to be less than alpha, the system categorizes this activity as a gesture and the system does not display a graphical cue to serve as a reminder that User D is interrupting. If the user activity is larger than beta, a graphical cue is amplified. If the detected activity is in between alpha and beta, and it is the first time that the activity is detected, the activity is ignored and the system does not display a graphical cue to serve as a reminder that User D is interrupting. However, if the detected activity is in between alpha and beta, and it is not the first time that the activity is detected, the system causes the cue to be amplified. A cue amplification can be an animation that draws user attention to a graphical element, like the notification transition in FIGS. 3A-3D, where the notification associated with the interjecting participant changes in size over time.

The amplification can be viewed by a specific user or by all users. If displayed to all users, there may be a visual association that relates the graphical cue, e.g., the graphical notification, to a user who is detected as the interrupting participant. The activity level can be any performance metric, which may include a volume level, a degree of movement, a number of spoken words, etc. Alpha and beta are used as examples of sample thresholds for any detected activity level. In these examples, each threshold can be at the same level or at different levels.

In some embodiments, the system can utilize a LLM to recognize users based on voice characteristics and word choice characteristics. In such embodiments, the system may store a sample set of a person's transcripts or audio clips with a profile. This profile information can be used to train the LLM so that the LLM has a sample set of each person's characteristics. This training data can also include data defining each person's tone, vocal inflections, word choice combinations, etc. The training data can also include audio clips of a recording with metadata identifying a person who is supposed to be talking at that time. Then, during a meeting, each person can be identified by sending an audio clip or transcript of a meeting with a prompt to instruct the LLM to identify each user based on the training data. This can be used by the LLM to determine the identify of each person in a meeting in addition to identifying who the interrupting user is. The LLM can also generate data indicating if the interruption causes a display of a notification or not cause a display of the notification. For example, if a statement of an interrupting person is not related to the same topic as a presenter, the system may generate a notification. If a statement of the interrupting person is related to the same topic as a presenter, the system may not generate a notification.

In one illustrative example where an LLM is used to determine if User D is interrupting User C and User B, the system may send audio data of a meeting to the LLM to determine if User D is interrupting User C and User B. A query to the LLM may include the ID each user and metadata defining a timeline of audio clip and speakers for each statement. The system may also generate prompt with ID's of each person instructing the LLM to determine if User D is interrupting User C and User B. This prompt may also include the identification of a designated speaker, e.g., User C and User B. This can cause the LLM to generate instructions indicating whether the notification is to be displayed to User D.

By using an LLM to identify interrupting users, the system can be more accurate in avoiding false positive notifications. This allows a system to only present notifications based on who is actually interrupting other users, instead of relying on volume detection only. For example, in some systems that only base interruptions based on volume, a system may generate an interruption notification with background noise.

The system can also control the volume of the participant who is interrupting the designated presenter. For example, the system can determine that a predetermined time period has lapsed after the interjecting participant, e.g., User 4 10D, has started speaking. In response to determining that the interjecting participant continues to speak above a threshold for the predetermined time period and/or is speaking over a threshold volume or reaches a threshold number of words, the system can reduce or mute a volume of an audio stream of the interjecting participant. These permission changes can also be temporary, e.g., the attenuated or muted volume may return to a normal level after the interjecting participant stops speaking. As shown in FIG. 3E, the system can also provide an indication of these permission changes. As shown, the system can generate a graphical indicator to show that User 4 has been muted.

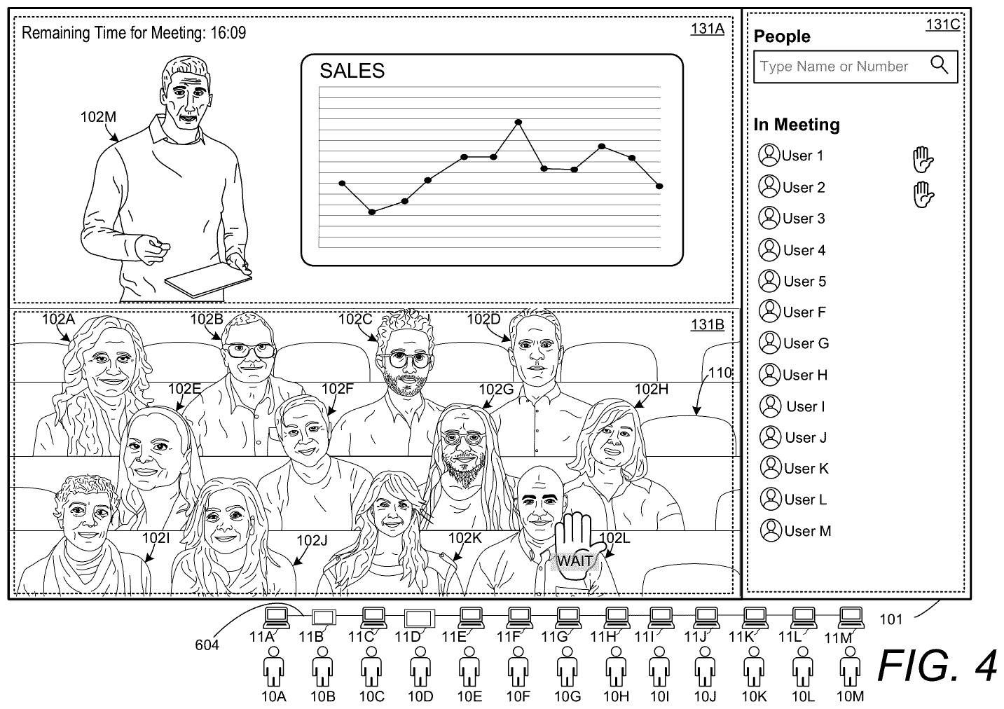

FIG. 4 shows another example of a graphical indicator that is displayed in association with the interjecting participant. In this example, the system generates a notification over a rendering 102L representing the interjecting participant. This can also include text to provide instruction to the interjecting participant.

The system can monitor participants by the use of an audio sensor to determine if a volume or voice pattern meets one or more criteria. For example, if the volume of a particular audience member or a number of words spoken by the audience member exceeds a threshold, the system determines that the audience member has interrupted the designated presenter. Other sensors can be used. For example, a camera may be used to capture the movement of a particular audience member. If the movement indicates that a person is speaking, the system determines that the audience member has interrupted the designated presenter. Although the examples herein indicate that audience members are monitored, the system can monitor any activity of any participant having a role other than a presenter role.

In some embodiments, the system can send portions of a live transcript to a large language model to monitor the activity of audience members and provide a notification to an interjecting participant. This enables the system to determine a context of a conversation to identify a participant that is interrupting a designated presenter. This embodiment enables the system to allow users to contribute to the conversation if they make a comment that is contextually relevant or if they are adding to the conversation. However, if the person diverges to a particular topic or interrupts with an unrelated topic, the system can identify that person as an interjecting participant and then provide a notification to curb that activity.

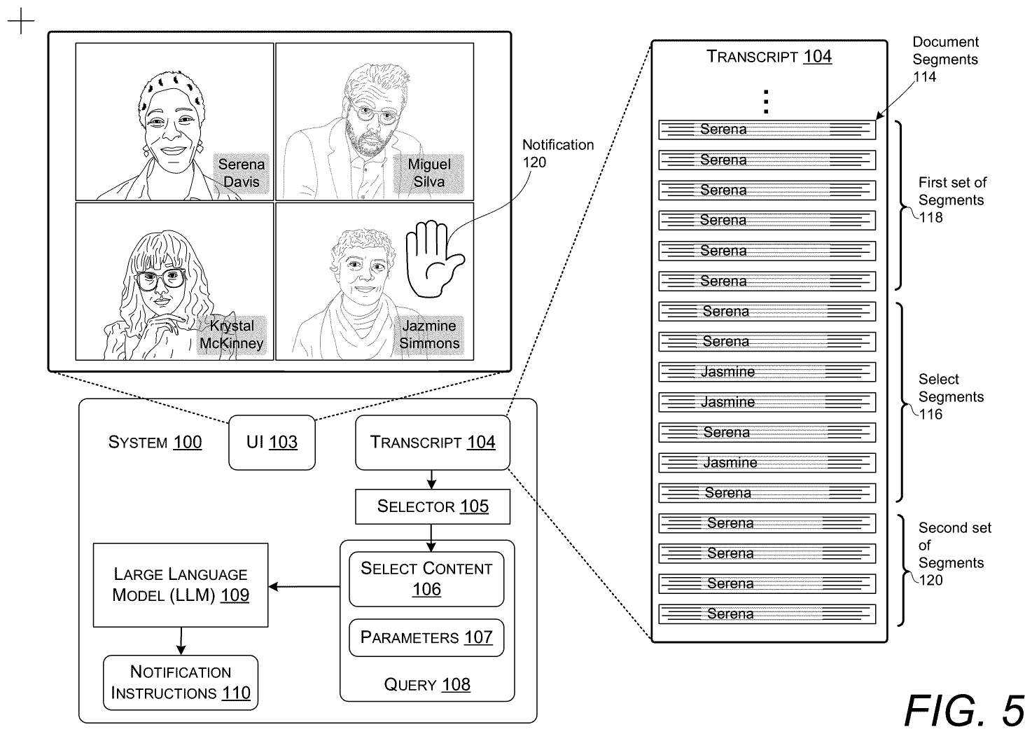

FIG. 5 shows an embodiment of the system 100 that can be used to identify an interjecting participant using a large language model. This embodiment includes a selector module 105 that can be used to identify portions of a live meeting transcript 104. The selector module identifies portions of the transcript based on the activity of the meeting participants. For example, if a meeting includes a person who is a designated presenter, and the system detects that a second person's live audio signal indicates that the second person, who is not a designated presenter, has started to speak, the selector can identify a set of segments 116 from the transcript 104 to be sent as select content 106 to a large language model (LLM) 109. The select content 106 can be sent to the LLM with parameters 107 such as query prompts and policies. The query prompts and policies can include instructions that cause the LLM to determine if one person's statements are actually interrupting another person's statements. The LLM can then generate notification instructions 1101, which may cause the system to generate a notification 120 if the LLM determines that one person's statements interrupted a designated presenter.

In some embodiments, the system can select segments of text from a transcript of a meeting, where each segment identifies individual participants. Each segment can include specific statements by individual people. For instance, as shown in FIG. 5, the system can determine that during Serena's presentation, several statements are made, which are included in a first set of segments 118, also referred to herein as “other statements.” The user can be identified in each segment, and the ID of each user can be generated by the computer of the user providing the corresponding segment. For instance, the first set of segments 118 can be from Serena's computer and the ID of her presentation statements can be generated by her computer.

The system may identify select segments 116 in response to the detention of predetermined events. For example, select segments 116 can be identified when statements are detected by two or more individuals. In this example, since Jasmine started to speak, the system can select a predetermined number of segments before Jasmine's statements and also select Jasmine's statements. Other segments can be selected to allow a large language model to identify a context for each statement. The select segments 116 can that be used to generate select content 106 for an LLM query 108.

The system can also generate parameters 107 for the query 108. The parameters can include instructions for the LLM to determine if one user has interrupted another user. For example, the parameters may include definitions that confirm that Serena's speech is in the first two segments, and that Jasmine's speech is in the third and fourth segments. The instructions can also be configured to cause the LLM to determine if a context of Serena's speech is consistent with a context of Serena's speech. If the two users are talking about the same topic, the LLM will generate notification instructions 110 that do not cause the system to display a notification 120 on the user interface 103. However, if the LLM determines that the context of Serena's speech is not consistent with a context of Serena's speech, e.g., they are on two separate topics, the system will generate notification instructions 110 that cause the system to display the notification 120 on the user interface 103. This example is provided for illustrative purposes and is not to be construed as limiting. It can be appreciated that the parameters can include any type of instructions that cause the LLM to determine if the context of speech of a designated presenter is different than the context of speech of other people who are not designated presenters. If the context has a threshold difference, then the system can generate a notification for those other people who are talking.

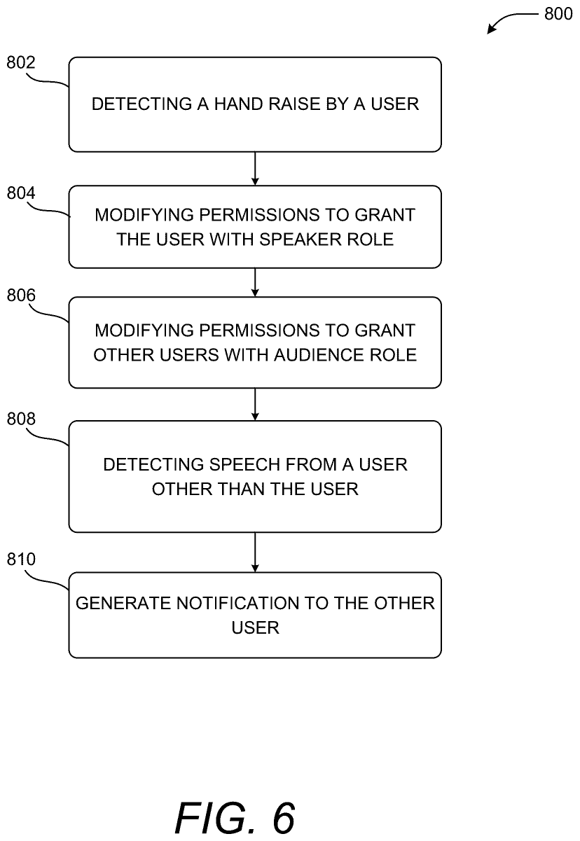

Turning now to FIG. 6, aspects of a routine 800 that causes a generation of a notification for an interjecting participant are shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media and computer-readable media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine are described herein as being implemented, at least in part, by an application, component and/or circuit, such as a device module that can be included in any one of the memory components disclosed herein, including but not limited to RAM. In some configurations, the device module can be a dynamically linked library (DLL), a statically linked library, functionality enabled by an application programing interface (API), a compiled program, an interpreted program, a script or any other executable set of instructions. Data, such as input data or a signal from a sensor, received by the device module can be stored in a data structure in one or more memory components. The data can be retrieved from the data structure by addressing links or references to the data structure.

Although the following illustration refers to the components depicted in the present application, it can be appreciated that the operations of the routine may be also implemented in many other ways. For example, the routine may be implemented, at least in part, by a processor or circuit of another remote computer (which can be a server) or a local processor or circuit of a local computer (which can be a client device receiving a message or a client device sending the message). Any aspect of the routine, which can include the generation of a prompt, communication of any of the messages with the prompt to an NLP algorithm, use of an NLP algorithm, or a display of a result generated by an NLP algorithm, can be performed on either a device sending a message, a device receiving a message, or on a server managing communication of the messages for a thread. In addition, one or more of the operations of the routine may alternatively or additionally be implemented, at least in part, by a chipset working alone or in conjunction with other software modules. Any service, circuit or application suitable for providing input data indicating the position or state of any device may be used in operations described herein.

The routine starts at operation 802 where the system detects a hand raise by a user indicating an interest to enter the speaker queue. For example, as shown in FIGS. 2A-2B, User 1 raises their hand. This can be done with a hand-raise button, gesture captured by a camera indicating that the person raised their hand or mentioned they would like to speak, or by the use of an AI model analyzing a transcript and configured to grant a speaker role when the person raises an interest to speak. In some embodiments, the system can receive an input from a first computing device 11A of a first participant 10B for invoking an operating state of the system 100 granting the first participant 10A with speaker permissions, wherein other participants of the meeting are assigned with audience permissions.

At operation 804, the system modifies permissions to grant the user who first provided an input to request to become a speaker, e.g., the first participant 10B, with a speaker role in the meeting. This enables the user to have audio and video broadcast rights to other users. The speaker role may also provide a feature where others are provided notice while the user is speaking or while the user is assigned the speaker role.

At operation 806, the system modifies permissions to grant the other users, other than the user who first provided an input to become a speaker, e.g., as second participant 10D, with an audience role in the meeting. This enables the other users to have limited audio and video broadcast rights to other users. For instance, these other users may only be able to speak for a predetermined time while a person has a speaker role. During the predetermined time the others users will receive a warning notification, e.g., a graphical indicator on their computer, and then they are muted after the predetermined time.

At operation 808, the system detects a subsequent input from other computing devices of the other users, e.g., other than the user with a speaker role, the second participant 10D. For example, the subsequent input can be an audio signal that indicates that the second participant 10D is speaking while the first participant 10B is assigned with the speaker permissions. An example of this is shown in FIG. 2C where User 2 (the “second participant 10D”) is detected as speaking out of turn detection is by audio signal, camera movement, or by AI analyzing a live transcript, it can be from the server or other computers.

At operation 810, the system generates a notification to the other user who is speaking during a time when the user has a speaking role. This notification can be generated in response to detecting that the second participant 10D is speaking while the first participant 10B is assigned with the speaker permissions. This notification can include operations for causing a second computing device 11D associated with the second participant 10D to generate a graphical element 120 indicating that the second participant 10D is speaking out of turn. This notification may not be displayed on the devices or screens of other users who are not interrupting the first participant.

Although the examples disclosed herein refer to the use of an LLM, the techniques disclosed herein can utilize any combination of suitable NLP algorithms that analyze and model interactions between devices and human language. Thus, the generation of the summary can also include other types of information, such as voice tone, voice volume, or voice inflections from a recording. These types of input can also enable the system to generate more accurate summaries that emphasize special points, etc. The NLP algorithms can include, but is not limited to, any suitable combination of algorithms such as Tokenization algorithms that divide a text into individual words or tokens; Part-of-Speech POS Tagging algorithms that assign grammatical labels e.g., noun, verb, adjective to each word in a sentence, helping to analyze sentence structure; Named Entity Recognition NER algorithms that identify and classify named entities, such as names of people, places, organizations, and more within a text; Sentiment Analysis algorithms that determine the sentiment or emotional tone of a piece of text, and classifying it as positive, negative, or neutral; Text Classification algorithms that categorize text documents into predefined classes or categories, such as topic classification and sentiment analysis; Machine Translation algorithms, like neural machine translation NMT, automatically translate text from one language to another; Language Modeling algorithms, including n-grams and neural language models, an also to referred to herein as a large language model LLM or a “language model,” are used to predict the probability of a word or sequence of words given the context of the preceding words; Named Entity Disambiguation algorithms which help disambiguate the meaning of named entities by linking them to specific entities in a knowledge base or resolving them to their appropriate entities; Text Summarization algorithms that generate concise summaries of longer texts, which can be extractive selecting and combining sentences or abstractive generating new sentences; Speech Recognition algorithms, since the system may process speech messages and not just text messages; Information Extraction algorithms that identify structured information from unstructured text, for extracting events or facts from articles or message attachments; Coreference Resolution algorithms that determine which words or phrases in a text refer to the same entity, e.g., identifying that “he” and “John” refer to the same person in a sentence; Question Answering algorithms that answer questions posed in natural language by extracting relevant information from text corpora or knowledge bases; Word Embeddings algorithms that represent words as dense, continuous-valued vectors, which capture semantic relationships between words; Text Generation algorithms that use Recurrent Neural Networks RNNs and Transformers to create human-like text, including chatbots, content generation, and creative writing, Dependency Parsing algorithms that analyze the grammatical structure of sentences by identifying the relationships between words, including subjects, objects, and modifiers; Topic Modeling algorithms, such as Latent Dirichlet Allocation LDA, to uncover the underlying topics in a collection of documents; and Language Generation algorithms that create coherent and contextually relevant language, such as generating human-like responses in a conversational AI system.

In the examples provided herein, the segments of a transcript of messages of a chat thread can be sent to the LLM in conjunction with a prompt that can cause the language model to determine a relevancy level between any combination of segments. For example, this system can generate a prompt requesting a level relevancy level between a third segments and the first segments. The prompt can also include a request for a confidence level with respect to the relevancy level. This can cause the language model to return a value indicating irrelevancy level between each combination of segments and another value indicating a confidence level. If the relevancy level or a combination of the relevancy level and the confidence level, exceed one or more thresholds, the system can determine that the topic of the third segment and the topic of the first segment have a threshold level of relevancy. This can be useful in a situation where someone wants to ask a question about the presentation or has a relevant point to make, and in response, the system does not generate a false notification. This enables the system to be targeted in delivering warnings to people who contribute to a conversation.

FIGS. 1 and 2A-2C show one example of the operations of the routine, where User 1 raises hand using a “raise hand button,” and prior to the User 1 having a chance to speak, User 2 interrupts. A graphical notification of the hand-raise gesture is enhanced to gently remind User 2 that User 1 had requested to speak and that User 2 had taken User 1's turn. This routine generates a notification 120 for display to a to a meeting participant who is speaking out of turn, the computer-implemented method configured for execution on a system 100. FIGS. 2A-2B show an example where User 1 raises hand button, performs a gesture, or the system uses AI to determine if a person desires a speaker role. The above-described operations can include receiving an input from a first computing device 11B of a first participant 10B for invoking an operating state of the system 100 granting the first participant 10B with speaker permissions, wherein other participants of the meeting are assigned with audience permissions. FIG. 2C shows an example where User 2 is detected as speaking out of turn detection is by audio signal, camera movement, or by AI analyzing a live transcript, which can be determined from the server or other computers. The above-described operations can include determining that a second participant 10D is interrupting the first participant 10B while the first participant 10B is assigned with the speaker permissions. FIG. 2D shows an example where a notification is displayed to User 2 when speaking out of turn. The above-described operations include causing a second computing device 11D associated with the second participant 10D to generate a graphical element 120 indicating that the second participant 10D is speaking out of turn, in response to determining that the second participant 10D is interrupting the first participant 10B while the first participant 10B is assigned with the speaker permissions. FIGS. 3A-3D show an example where an enhancement could be an animation, e.g., a bigger size, or other transformation of the UI element. The operations can include a graphical element 120 that increases in size over time while the subsequent input indicates that the second participant 10D is speaking, wherein a rate of size increase and the size of the graphical element is based on a priority of first participant or a characteristic of the subsequent input.

FIG. 3E shows an example where a second user is muted after a period of time, if they continue speaking beyond a time limit. The routine can also include operations for determining that a predetermined time period has lapsed after the second participant has started speaking; and in response to determining that the second participant continues to speak above a threshold for the predetermined time period, reducing or muting a volume of an audio stream of the second user received from the second computing device by updating the permissions associated with the second participant.

FIG. 4 shows an example of a computer in Together Mode having people in a seating arrangement and also showing the notification. The routine includes a position of the graphical element 120 causes the graphical element 120 to overlap at least a portion of a rendering of the second participant 10D. The routine can also include operations where a position of the graphical element causes the graphical element to overlap at least a portion of a rendering of the second participant, wherein a user interface displaying the graphical element includes a presenter region and an audience region, the audience region including individual renderings of the participants, and the individual renderings each have a position relative to a seating configuration of a virtual environment.

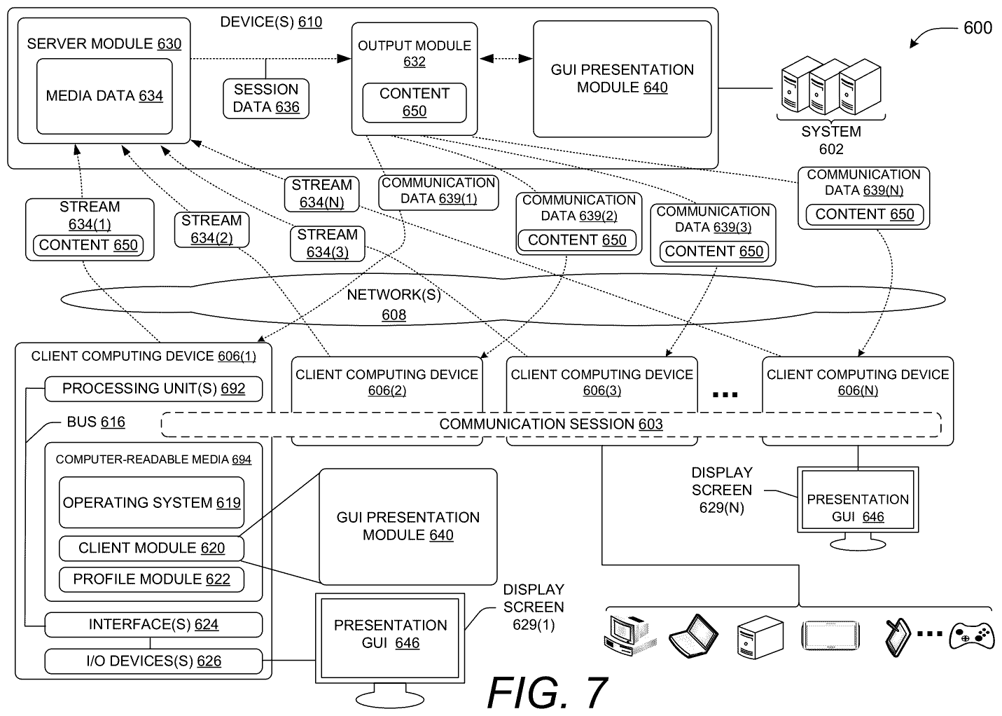

Turning now to FIG. 7, a diagram illustrating an example environment 600 in which a system 602 can implement the disclosed techniques is shown. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, a system 602 may function to collect, analyze, and share data that is displayed to users of a communication session 604. As illustrated, the communication session 603 may be implemented between a number of client computing devices 606(1) through 606(N) (where N is a number having a value of two or greater) that are associated with or are part of the system 602. The client computing devices 606(1) through 606(N) enable users, also referred to as individuals, to participate in the communication session 603.

In this example, the communication session 603 is hosted, over one or more network(s) 608, by the system 602. That is, the system 602 can provide a service that enables users of the client computing devices 606(1) through 606(N) to participate in the communication session 603 (e.g., via a live viewing and/or a recorded viewing). Consequently, a “participant” to the communication session 603 can comprise a user and/or a client computing device (e.g., multiple users may be in a room participating in a communication session via the use of a single client computing device), each of which can communicate with other participants. As an alternative, the communication session 603 can be hosted by one of the client computing devices 606(1) through 606(N) utilizing peer-to-peer technologies. The system 602 can also host chat conversations and other team collaboration functionality (e.g., as part of an application suite).

In some implementations, such chat conversations and other team collaboration functionality are considered external communication sessions distinct from the communication session 603. A computing system 602 that collects participant data in the communication session 603 may be able to link to such external communication sessions. Therefore, the system may receive information, such as date, time, session particulars, and the like, that enables connectivity to such external communication sessions. In one example, a chat conversation can be conducted in accordance with the communication session 603. Additionally, the system 602 may host the communication session 603, which includes at least a plurality of participants co-located at a meeting location, such as a meeting room or auditorium, or located in disparate locations.

In examples described herein, client computing devices 606(1) through 606(N) participating in the communication session 603 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds can be communicated with the messages.

The system 602 of FIG. 7 includes device(s) 610. The device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 603. As an example, the system 602 may be managed by entities such as SLACK, WEBEX, GOTOMEETING, GOOGLE HANGOUTS, etc.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 608 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 610 may include one or more computing devices that operate in a cluster or other grouped configuration to share resources, balance load, increase performance, provide fail-over support or redundancy, or for other purposes. For instance, device(s) 610 may belong to a variety of classes of devices such as traditional server-type devices, desktop computer-type devices, and/or mobile-type devices. Thus, although illustrated as a single type of device or a server-type device, device(s) 610 may include a diverse variety of device types and are not limited to a particular type of device. Device(s) 610 may represent, but are not limited to, server computers, desktop computers, web-server computers, personal computers, mobile computers, laptop computers, tablet computers, or any other sort of computing device.

A client computing device (e.g., one of client computing device(s) 606(1) through 606(N)) (each of which are also referred to herein as a “data processing system”) may belong to a variety of classes of devices, which may be the same as, or different from, device(s) 610, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 606(1) through 606(N) of the various classes and device types can represent any type of computing device having one or more data processing unit(s) 692 operably connected to computer-readable media 694 such as via a bus 616, which in some instances can include one or more of a system bus, a data bus, an address bus, a PCI bus, a Mini-PCI bus, and any variety of local, peripheral, and/or independent buses. Executable instructions stored on computer-readable media 694 may include, for example, an operating system 619, a client module 620, a profile module 622, and other modules, programs, or applications that are loadable and executable by data processing units(s) 692.

Client computing device(s) 606(1) through 606(N) may also include one or more interface(s) 624 to enable communications between client computing device(s) 606(1) through 606(N) and other networked devices, such as device(s) 610, over network(s) 608. Such network interface(s) 624 may include one or more network interface controllers (NICs) or other types of transceiver devices to send and receive communications and/or data over a network. Moreover, client computing device(s) 606(1) through 606(N) can include input/output (“I/O”) interfaces (devices) 626 that enable communications with input/output devices such as user input devices including peripheral input devices (e.g., a game controller, a keyboard, a mouse, a pen, a voice input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 7 illustrates that client computing device 606(1) is in some way connected to a display device (e.g., a display screen 629(N)), which can display a UI according to the techniques described herein.

In the example environment 600 of FIG. 7, client computing devices 606(1) through 606(N) may use their respective client modules 620 to connect with one another and/or other external device(s) in order to participate in the communication session 603, or in order to contribute activity to a collaboration environment. For instance, a first user may utilize a client computing device 606(1) to communicate with a second user of another client computing device 606(2). When executing client modules 620, the users may share data, which may cause the client computing device 606(1) to connect to the system 602 and/or the other client computing devices 606(2) through 606(N) over the network(s) 608.

The client computing device(s) 606(1) through 606(N) may use their respective profile modules 622 to generate participant profiles (not shown in FIG. 7) and provide the participant profiles to other client computing devices and/or to the device(s) 610 of the system 602. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 7, the device(s) 610 of the system 602 include a server module 630 and an output module 632. In this example, the server module 630 is configured to receive, from individual client computing devices such as client computing devices 606(1) through 606(N), media streams 634(1) through 634(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 630 is configured to receive a collection of various media streams 634(1) through 634(N) during a live viewing of the communication session 603 (the collection being referred to herein as “media data 634”). In some scenarios, not all of the client computing devices that participate in the communication session 603 provide a media stream. For example, a client computing device may only be a consuming, or a “listening”, device such that it only receives content associated with the communication session 603 but does not provide any content to the communication session 603.

In various examples, the server module 630 can select aspects of the media streams 634 that are to be shared with individual ones of the participating client computing devices 606(1) through 606(N). Consequently, the server module 630 may be configured to generate session data 636 based on the streams 634 and/or pass the session data 636 to the output module 632. Then, the output module 632 may communicate communication data 639 to the client computing devices (e.g., client computing devices 606(1) through 606(3) participating in a live viewing of the communication session). The communication data 639 may include video, audio, and/or other content data, provided by the output module 632 based on content 650 associated with the output module 632 and based on received session data 636. The content 650 can include the streams 634 or other shared data, such as an image file, a spreadsheet file, a slide deck, a document, etc. The streams 634 can include a video component depicting images captured by an I/O device 626 on each client computer. The content 650 also include input data from each user, which can be used to control a direction and location of a representation. The content can also include instructions for sharing data and identifiers for recipients of the shared data. Thus, the content 650 is also referred to herein as input data 650 or an input 650.

As shown, the output module 632 transmits communication data 639(1) to client computing device 606(1), and transmits communication data 639(2) to client computing device 606(2), and transmits communication data 639(3) to client computing device 606(3), etc. The communication data 639 transmitted to the client computing devices can be the same or can be different (e.g., positioning of streams of content within a user interface may vary from one device to the next).

In various implementations, the device(s) 610 and/or the client module 620 can include GUI presentation module 640. The GUI presentation module 640 may be configured to analyze communication data 639 that is for delivery to one or more of the client computing devices 606. Specifically, the UI presentation module 640, at the device(s) 610 and/or the client computing device 606, may analyze communication data 639 to determine an appropriate manner for displaying video, image, and/or content on the display screen 629 of an associated client computing device 606. In some implementations, the GUI presentation module 640 may provide video, image, and/or content to a presentation GUI 646 rendered on the display screen 629 of the associated client computing device 606. The presentation GUI 646 may be caused to be rendered on the display screen 629 by the GUI presentation module 640. The presentation GUI 646 may include the video, image, and/or content analyzed by the GUI presentation module 640.

In some implementations, the presentation GUI 646 may include a plurality of sections or grids that may render or comprise video, image, and/or content for display on the display screen 629. For example, a first section of the presentation GUI 646 may include a video feed of a presenter or individual, a second section of the presentation GUI 646 may include a video feed of an individual consuming meeting information provided by the presenter or individual. The GUI presentation module 640 may populate the first and second sections of the presentation GUI 646 in a manner that properly imitates an environment experience that the presenter and the individual may be sharing.

In some implementations, the GUI presentation module 640 may enlarge or provide a zoomed view of the individual represented by the video feed in order to highlight a reaction, such as a facial feature, the individual had to the presenter. In some implementations, the presentation GUI 646 may include a video feed of a plurality of participants associated with a meeting, such as a general communication session. In other implementations, the presentation GUI 646 may be associated with a channel, such as a chat channel, enterprise Teams channel, or the like. Therefore, the presentation GUI 646 may be associated with an external communication session that is different from the general communication session.

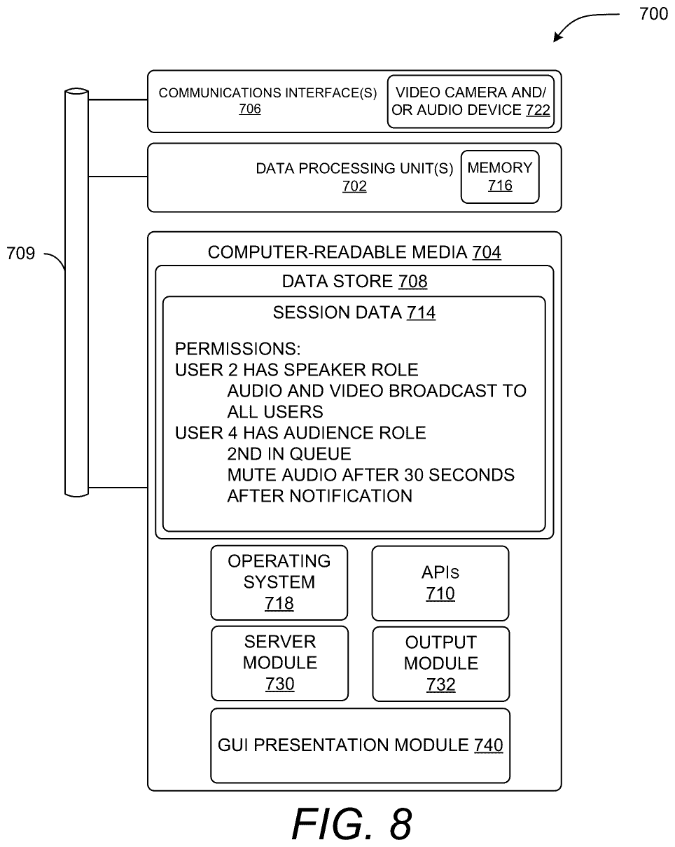

FIG. 8 illustrates a diagram that shows example components of an example device 700 (also referred to herein as a “computing device”) configured to generate data for some of the user interfaces disclosed herein. The device 700 may generate data that may include one or more sections that may render or comprise video, images, virtual objects, and/or content for display on the display screen 629. The device 700 may represent one of the device(s) described herein. Additionally, or alternatively, the device 700 may represent one of the client computing devices 606.

As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses.

As utilized herein, data processing unit(s), such as the data processing unit(s) 702 and/or data processing unit(s) 692, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 704 and computer-readable media 694, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, computer-readable storage medium, computer-readable storage device, or computer storage medium.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 706 may represent, for example, network interface controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704 includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 708 may store data for the operations of processes, applications, components, and/or modules stored in computer-readable media 704 and/or executed by data processing unit(s) 702 and/or accelerator(s). For instance, in some examples, the data store 708 may store session data 710 (e.g., session data 636 as shown in FIG. 7), profile data (e.g., associated with a participant profile), and/or other data. The session data 710 can include a total number of participants (e.g., users and/or client computing devices) in a communication session, activity that occurs in the communication session, a list of invitees to the communication session, and/or other data related to when and how the communication session is conducted or hosted. The data store 708 may also include session data 714, such as the content that includes video, audio, or other content that can be shared in a chat thread. This the session data 714 can also include permissions for each user. For example, a role of a designated presenter can be granted to User 2 and User 4 can have an audience role, where their speech is monitored to determine if they are interrupting the designated presenter. Other rules are defined as well, e.g., when the system mutes User 4, etc.

Alternately, some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) 710 (APIs) configured to expose the functionality and the data of the device 700 to other devices. Additionally, the computer-readable media 704 includes one or more modules such as the server module 730, the output module 732, and the GUI presentation module 740, although the number of illustrated modules is just an example, and the number may vary. That is, functionality described herein in association with the illustrated modules may be performed by a fewer number of modules or a larger number of modules on one device or spread across multiple devices.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A computer-implemented method for generating a notification to a meeting participant who is speaking out of turn, the computer-implemented method configured for execution on a system comprising:
receiving an input from a first computing device of a first participant for invoking an operating state of the system granting the first participant with speaker permissions, wherein other participants of the meeting are assigned with audience permissions;
determining that a second participant is interrupting the first participant while the first participant is assigned with the speaker permissions; and
in response to determining that the second participant is interrupting the first participant while the first participant is assigned with the speaker permissions, causing a second computing device associated with the second participant to generate a graphical element indicating that the second participant is speaking out of turn.

2. The method of claim 1, wherein the graphical element increases in size over time while the subsequent input indicates that the second participant is speaking, wherein a rate of size increase and the size of the graphical element is based on a priority of first participant or a characteristic of the subsequent input.

3. The method of claim 1, further comprising:
determining that a predetermined time period has lapsed after the second participant has started speaking; and
in response to determining that the second participant continues to speak above a threshold for the predetermined time period, reducing or muting a volume of an audio stream of the second user received from the second computing device by updating the permissions associated with the second participant.

4. The method of claim 1, wherein a position of the graphical element causes the graphical element to overlap at least a portion of a rendering of the second participant.

5. The method of claim 1, wherein a position of the graphical element causes the graphical element to overlap at least a portion of a rendering of the second participant, wherein a user interface displaying the graphical element includes a presenter region and an audience region, the audience region including individual renderings of the participants, and the individual renderings each have a position relative to a seating configuration of a virtual environment.

6. The method of claim 1, wherein determining that a second participant is interrupting the first participant comprises:
identifying select segments of a transcript of a meeting based on the identification of at least two individual participants being associated with individual segments of the select segments;
generating a query that includes the select segments, wherein the query includes parameters that associates individual segments that are associated with the first participant and other individual segments that are associated with the second participant, the parameters further define instructions that cause a large language model to determine if a first context of the individual segments and a second context of the other individual segments have a threshold difference;
communicating the query to the large language model causing the large language model to determine if the first context of the individual segments and the second context of the other individual segments have the threshold difference; and
receiving instructions from the large language model, the instructions indicating that the second participant is interrupting the first participant while the first participant when the first context of the individual segments and the second context of the other individual segments have the threshold difference.

7. The method of claim 1, wherein the parameters further cause the large language model to determine a confidence level with respect to the first context and the second context, wherein the instructions indicate that the second participant is interrupting the first participant when the first context of the individual segments and the second context of the other individual segments have the threshold difference and when the confidence level with respect to the first context and the second context has a threshold confidence level.

8. A computing system for generating a notification to a meeting participant who is speaking out of turn, the computing system comprising:
one or more processing units; and
a computer-readable storage medium having encoded thereon computer-executable instructions to cause the one or more processing units to:
receive an input from a first computing device of a first participant for invoking an operating state of the system granting the first participant with speaker permissions, wherein other participants of the meeting are assigned with audience permissions;
determine that a second participant is interrupting the first participant while the first participant is assigned with the speaker permissions; and
in response to determining that the second participant is interrupting the first participant while the first participant is assigned with the speaker permissions, cause a second computing device associated with the second participant to generate a graphical element indicating that the second participant is speaking out of turn.

9. The computing system of claim 8, wherein the graphical element increases in size over time while the subsequent input indicates that the second participant is speaking, wherein a rate of size increase and the size of the graphical element is based on a priority of first participant or a characteristic of the subsequent input.

10. The computing system of claim 8, wherein the instructions further cause the one or more processing units to:
determine that a predetermined time period has lapsed after the second participant has started speaking; and
in response to determining that the second participant continues to speak above a threshold for the predetermined time period, reduce or mute a volume of an audio stream of the second user received from the second computing device by updating the permissions associated with the second participant.

11. The computing system of claim 8, wherein a position of the graphical element causes the graphical element to overlap at least a portion of a rendering of the second participant.

12. The computing system of claim 8, wherein a position of the graphical element causes the graphical element to overlap at least a portion of a rendering of the second participant, wherein a user interface displaying the graphical element includes a presenter region and an audience region, the audience region including individual renderings of the participants, and the individual renderings each have a position relative to a seating configuration of a virtual environment.

13. The computing system of claim 8, wherein determining that a second participant is interrupting the first participant comprises:
identifying select segments of a transcript of a meeting based on the identification of at least two individual participants being associated with individual segments of the select segments;
generating a query that includes the select segments, wherein the query includes parameters that associates individual segments that are associated with the first participant and other individual segments that are associated with the second participant, the parameters further define instructions that cause a large language model to determine if a first context of the individual segments and a second context of the other individual segments have a threshold difference;
communicating the query to the large language model causing the large language model to determine if the first context of the individual segments and the second context of the other individual segments have the threshold difference; and
receiving instructions from the large language model, the instructions indicating that the second participant is interrupting the first participant while the first participant when the first context of the individual segments and the second context of the other individual segments have the threshold difference.

14. The computing system of claim 8, wherein the parameters further cause the large language model to determine a confidence level with respect to the first context and the second context, wherein the instructions indicate that the second participant is interrupting the first participant when the first context of the individual segments and the second context of the other individual segments have the threshold difference and when the confidence level with respect to the first context and the second context has a threshold confidence level.

15. A computer-readable storage medium having encoded thereon computer-executable instructions for generating a notification to a meeting participant who is speaking out of turn, the computer-executable instructions configured to cause the one or more processing units of a computing system to:
receive an input from a first computing device of a first participant for invoking an operating state of the system granting the first participant with speaker permissions, wherein other participants of the meeting are assigned with audience permissions;
determine that a second participant is interrupting the first participant while the first participant is assigned with the speaker permissions; and
in response to determining that the second participant is interrupting the first participant while the first participant is assigned with the speaker permissions, cause a second computing device associated with the second participant to generate a graphical element indicating that the second participant is speaking out of turn.

16. The computer-readable storage medium of claim 15, wherein the graphical element increases in size over time while the subsequent input indicates that the second participant is speaking, wherein a rate of size increase and the size of the graphical element is based on a priority of first participant or a characteristic of the subsequent input.

17. The computer-readable storage medium of claim 15, wherein the instructions further cause the one or more processing units to:
determine that a predetermined time period has lapsed after the second participant has started speaking; and
in response to determining that the second participant continues to speak above a threshold for the predetermined time period, reduce or mute a volume of an audio stream of the second user received from the second computing device by updating the permissions associated with the second participant.

18. The computer-readable storage medium of claim 15, wherein a position of the graphical element causes the graphical element to overlap at least a portion of a rendering of the second participant.

19. The computer-readable storage medium of claim 15, wherein a position of the graphical element causes the graphical element to overlap at least a portion of a rendering of the second participant, wherein a user interface displaying the graphical element includes a presenter region and an audience region, the audience region including individual renderings of the participants, and the individual renderings each have a position relative to a seating configuration of a virtual environment.

20. The computer-readable storage medium of claim 15, wherein determining that a second participant is interrupting the first participant comprises:
identifying select segments of a transcript of a meeting based on the identification of at least two individual participants being associated with individual segments of the select segments;
generating a query that includes the select segments, wherein the query includes parameters that associates individual segments that are associated with the first participant and other individual segments that are associated with the second participant, the parameters further define instructions that cause a large language model to determine if a first context of the individual segments and a second context of the other individual segments have a threshold difference;
communicating the query to the large language model causing the large language model to determine if the first context of the individual segments and the second context of the other individual segments have the threshold difference; and
receiving instructions from the large language model, the instructions indicating that the second participant is interrupting the first participant while the first participant when the first context of the individual segments and the second context of the other individual segments have the threshold difference.
